(19) United States
(12) Patent Application Publication
(10) Pub. No.: US 2009/0034128 A1
(43) Pub. Date: Feb. 5, 2009

(54) Method and apparatus for independent piezoelectric excitation in the micro-actuator assemblies of a hard disk drive for improved drive reliability

(76) Inventors: Vinod Sharma, Los Gatos, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/897,936

(22) Filed: Aug. 31, 2007

Related U.S. Application Data
(60) Provisional application No. 60/961,303, filed on Jul. 21, 2007.

(51) Int. Cl. G11B 21/24

(52) U.S. Cl. 360/294.4; G9B/21.028

(57) ABSTRACT

A hard disk drive using a micro-actuator assembly to position a slider over a track on a rotating disk surface. The micro-actuator assembly includes a first piezoelectric device and a second piezoelectric device, both mechanically coupled to the slider. The first piezoelectric device includes a first terminal electrically coupled to a first voltage line and a second terminal electrically coupled to a ground line. The second piezoelectric device includes a third terminal electrically coupled to a ground line and a fourth terminal electrically coupled to a voltage line. A voltage applied to the first voltage line stimulates only the first piezoelectric device to alter a lateral position of the slider over the rotating disk surface, and a second voltage applied to the second voltage line stimulates only the second piezoelectric device to alter the lateral position of the slider over the rotating disk surface.

### RELATED APPLICATIONS

This application claims the benefit of the priority date of provisional patent application Ser. No. 60/961,303, filed Jul. 21, 2007, the specification of which is hereby incorporated in its entirety.

### TECHNICAL FIELD

This invention relates to the excitation of dual piezoelectric elements in a micro-actuator assembly positioning a slider in a hard disk drive.

### BACKGROUND OF THE INVENTION

Hard disk drives typically use a voice coil motor to position read-write heads over specific track on the rotating disk. With ever increasing track density, recently some hard disk drives are using both a voice coil motor for coarse positioning and micro-actuator assemblies for fine positioning of the heads over data track. Both the voice coil motor and each of the micro-actuator assemblies couple to a slider, and both exert a force upon the slider to position the read-write head laterally over a rotating disk surface to access the data stored there.

Frequently, the micro-actuator assemblies include a pair of piezoelectric devices 282 and 284, which are connected in series. The micro-actuator assemblies are often controlled by driving the pair with a “high” voltage across them. This voltage is frequently on during normal operations even when one or both of the piezoelectric devices in the micro-actuator assembly are not being used, which may affect the reliability of the micro-actuator assembly by degrading the piezoelectric devices over time.

Typical prior art devices can be seen in FIGS. 4A to 4C. As shown in FIG. 4A (prior art), the head gimbal assembly 26 provides the lateral control signal bundle 82 including a high voltage direct current line coupled to the fourth terminal 296 and a ground line to the first terminal 290. An alternating current control line 100 is provided to the electrical coupling between the second terminal 292 and the third terminal 294.

The head gimbal assembly 26 of FIG. 4A may be used with a micro-actuator driver 18 shown in FIG. 4B (prior art) including a direct current high voltage source driving the high voltage line of FIG. 4A, an alternating current lateral control signal source driving the alternating current lateral control line 100, and a direct current ground source electrically coupled to the ground line, where each of these lines is included in the prior art lateral control signal bundle 82.

As mentioned earlier, there are problems with the prior art approach which may be seen by looking at the simplified circuit schematic of FIG. 4C (prior art). The two piezoelectric devices and their driver lines are modeled here as capacitors connected in series, collectively experiencing a high voltage drop between the fourth terminal 296 and the first terminal 290 whenever the micro-actuator driver is turned on. This will always dissipate power across the piezoelectric devices, and because at least one and often both piezoelectric devices are being stimulated, may contribute to aging these devices, which may cause their performance to degrade. What is needed is a way to minimize the high voltage applied to the micro-actuator assemblies.

### SUMMARY OF THE INVENTION

Embodiments of the hard disk drive use a micro-actuator assembly including two or more piezoelectric devices connected in series with their coupled terminals being tied to ground. Applying a voltage to the other terminal of one of the piezoelectric devices stimulates just that piezoelectric device.

Upon stimulation, the piezoelectric device alters the lateral position of a slider coupled to it over the rotating disk surface in the hard disk drive. The micro-actuator driver provides the voltage stimulus to just one of the piezoelectric device terminals. By only dissipating power when one of the piezoelectric devices is needed, power is conserved, and the degradation of the piezoelectric devices over time may be reduced.

Several example embodiments of the hard disk drive are disclosed, the first using the micro-actuator driver in a preamplifier in the main flex circuit, the second using a separate micro-actuator driver in the main flex circuit, the third using the micro-actuator driver in the embedded circuit, and the fourth using the micro-actuator driver within a processor in the embedded circuit.

### BRIEF DESCRIPTION OF THE DRAWINGS

FIG. 1 shows a plan view of a hard disk drive embodiment with a rotating disk surface and a slider including a read-write head being positioned over a track on the rotating disk surface by the voice coil motor pivoting through at least one actuator arm and a head gimbal assembly to the slider;

FIG. 2A shows a perspective view of an embodiment of the voice coil motor of FIG. 1 including a head stack assembly with a voice coil coupled to the actuator arms and the head gimbal assemblies coupled to the actuator arms, as well as a main flex circuit and preamplifier;

FIG. 2B shows a side view of an embodiment of the head gimbal assembly of FIGS. 1 and 2A, with a micro-actuator assembly including the slider flying on an air bearing created by the wind off of the rotating disk surface, a flexure finger coupling to the micro-actuator assembly, and to a load beam coupling through a base plate to the actuator arm;

FIG. 2C shows a simplified plan view of an example embodiment of the micro-actuator assembly of FIG. 2B, further including a first piezoelectric device and a second piezoelectric device, both coupled to the slider;

FIG. 3 shows in a schematic fashion some further details of a first embodiment of the hard disk drive of FIG. 1 including the preamplifier generating a position error signal (PES) that is used by a processor in the embedded circuit to control a micro-actuator driver that electrically stimulates the micro-actuator assemblies in finely positioning the sliders over the rotating disk surfaces;

FIG. 4A shows a schematic of a prior art head gimbal assembly where the flexure finger provides a high voltage line and an alternating current control signal oscillating between the high voltage line and a ground line to control the first and second piezoelectric devices;

FIG. 4B shows a schematic of a micro-actuator driver of the prior art with a direct current high voltage source driving the high voltage line of FIG. 4A, an alternating current source driving the alternating current control signal, and a direct current ground source sinking the ground line;

FIG. 4C shows a simplified schematic of an equivalent circuit of the prior art micro-actuator driver of FIG. 4B coupled to the prior art head gimbal assembly of FIG. 4A, with the high voltage line always dissipating energy to the ground line whenever the driver is turned on;

FIG. 5A shows a schematic of an example embodiment of a head gimbal assembly of the invention, where each of the piezoelectric devices are driven by a separate high voltage control signal provided by a lateral control signal bundle, and the piezoelectric devices each have one terminal electrically coupled to a ground line;

FIG. 5B shows a schematic of an example embodiment of a micro-actuator driver including two high voltage sources, one for each of the separate high voltage control signals of the head gimbal assembly of FIG. 5A;

FIG. 5C shows a simplified schematic of an equivalent circuit of the micro-actuator driver of FIG. 5B coupled to the head gimbal assembly of FIG. 5A, showing energy dissipation only when one of the high voltage control signals is asserted;

FIG. 6A shows a second embodiment of the hard disk drive and the voice coil motor, with a main flex circuit including a micro-actuator driver separate from the preamplifier;

FIG. 6B shows a third embodiment of the hard disk drive and an embodiment of the embedded circuit, where the embedded circuit includes the micro-actuator driver and the processor; and

FIG. 6C shows a fourth embodiment of the hard disk drive and an embodiment of the embedded circuit, where the processor further includes the micro-actuator driver.

### DETAILED DESCRIPTION

Embodiments of the hard disk drive use a micro-actuator assembly including two or more piezoelectric devices connected in series with their coupled terminals being tied to ground. Applying a voltage to the other terminal of the piezoelectric device stimulates just that piezoelectric device. The voltage used in current preferred designs is typically around 10 to 20 times higher than the voltage used in the processor power supply. However lower voltages may be useable. Therefore the voltage applied to the piezoelectric devices may be interchangeably referred to herein as either “high voltage” or “voltage” because no specific voltage is required by the invention, but a high voltage as defined above is currently preferred. Upon stimulation, that piezoelectric device alters the lateral position of a slider coupled to it over the rotating disk surface in the hard disk drive. By only dissipating power when one of the piezoelectric devices is needed, power is conserved, and degradation of the piezoelectric devices over time may be reduced.

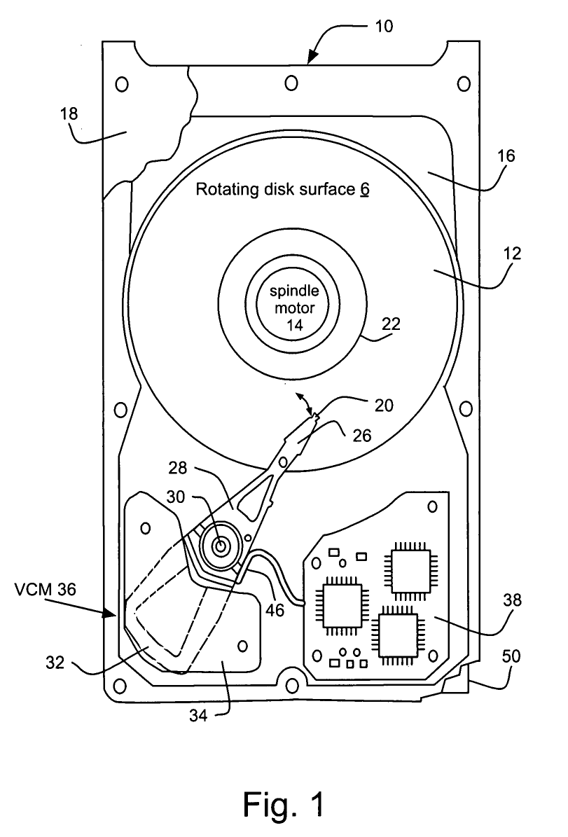

Referring to the drawings more particularly by reference numbers, FIG. 1 shows an embodiment of a hard disk drive 10. The hard disk drive may include one or more ferromagnetic disks 12 rotated by a spindle motor 14 to create at least one rotating disk 6. The spindle motor may be mounted to a base plate 16. The hard disk drive may further have a cover 18 that encloses the disks 12. The voice coil motor 36 operates by pivoting a head stack assembly through the actuator pivot 30, moving the actuator arms 28 and their coupled head gimbal assemblies 26 to laterally position a slider 20 near a track 22 on the rotating disk surface.

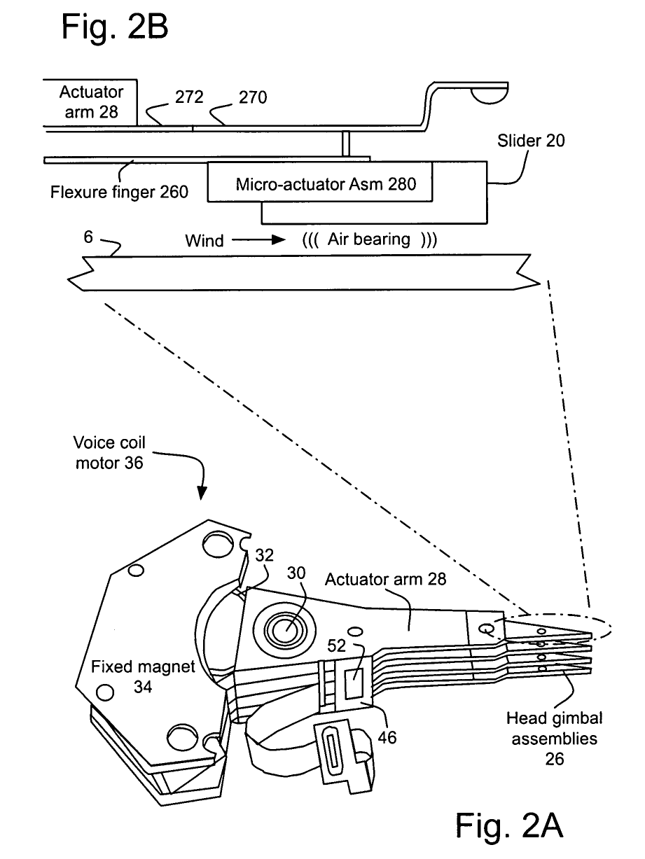

FIG. 2A shows some details of the voice coil motor 36 of FIG. 1 including more than one actuator arm 28 and more than one head gimbal assembly 26, as well as a main flex circuit 46 and a preamplifier 52 included in the main flex circuit. In certain embodiments, at least one of the actuator arms may couple with two separate head gimbal assemblies. As used herein, the head stack assembly will refer to the voice coil 32 coupled to the actuator arms, which in turn are coupled to head gimbal assemblies in a hard disk drive. The voice coil motor 36 includes the head stack assembly pivotably mounted by the actuator pivot 30 to the disk base 16 positioned with the voice coil 32 between the fixed magnet assembly 34, and with at least one head gimbal assembly 26 situated so the slider 20 is near the rotating disk surface 6.

FIG. 2B shows some details of an example embodiment of the head gimbal assembly 26 of the preceding Figures, with a micro-actuator assembly 280 including the slider 20, a flexure finger 260 coupling to the micro-actuator assembly, and to a load beam 270. The load beam couples through a base plate 272 to the actuator arm 28. The rotating disk surface 6 creates a wind that lifts the slider 20 on its air bearing off the disk surface.

FIG. 2C shows some detail of an example embodiment of the micro-actuator assembly 280 of FIG. 2B, including a first piezoelectric device 282 and a second piezoelectric device 284, both coupled to the slider 20 with its read/write head 24.

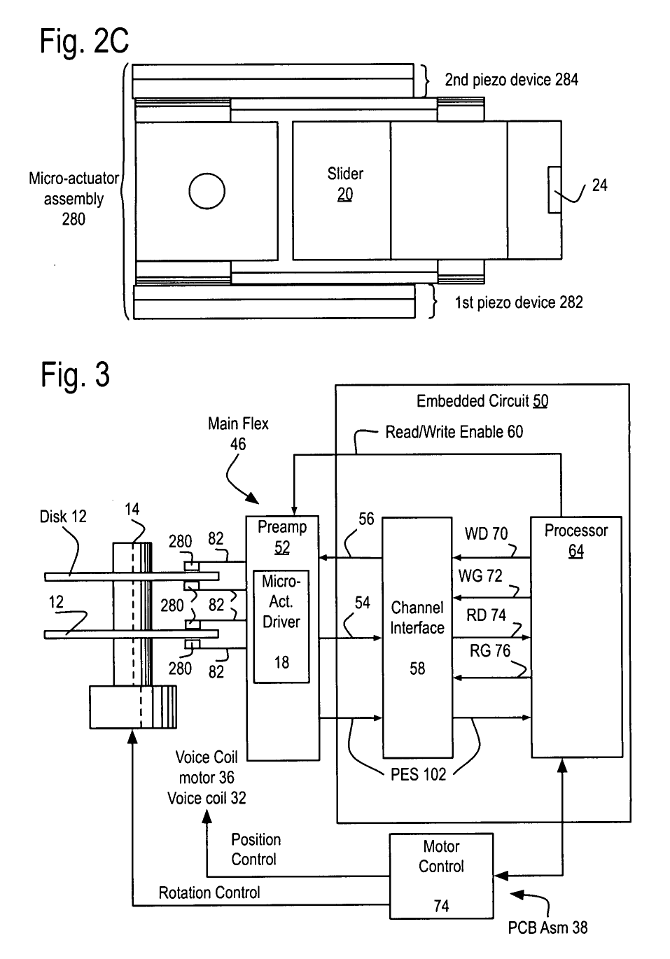

FIG. 3 shows in a schematic fashion some further details of FIG. 1 including the preamplifier 52 generating a position error signal (PES) that is used by a processor 64 in the embedded circuit 50 to control a micro-actuator driver 18, which electrically stimulates the micro-actuator assembly 280 to laterally position the slider 20 over a surface of the rotating disk 12.

A processor 64 in the embedded circuit 50 typically controls the operation of the hard disk drive 10. To access data, the processor stimulates a motor control 74 to create a rotation control signal fed to the spindle motor 14, which responds by rotating the disks 12, creating the rotating disk surfaces 6. When the disks reach an operational rotation rate, the processor then stimulates a position control signal which acts as a time varying electrical stimulus to the voice coil 32 in the voice coil motor 36. From the stimulus to the voice coil and its magnetic interaction with the fixed magnet assembly 34, the head stack assembly pivots through the actuator pivot 30, sending the actuator arms 28 and their coupled head gimbal assemblies 26 to position a slider 20 near a track 22 on the rotating disk surface 6. At this point, the hard disk drive enters into an operational mode referred to as track following and may preferably use the apparatus and method of this invention to stimulate the micro-actuator assembly 280 to laterally position the read-write head 24 close enough to the track 22 access its data.

Often a read/write enable signal 60 is used to determine whether reading or writing data is to be done. When writing, the write control signals 72 are used in conjunction with the write data 70 to create the write channel 56, which is sent to the preamplifier, and from there to a slider in one of the head gimbal assemblies 26. When reading, a read channel 54 is generated from a read signal generated by the slider, which is sent as the read data 74 to the processor. There are often additional read controls 76 that are used. Frequently, the preamplifier derives a position error signal 102 from the read signal generated by the read head in the read-write head 24. The position error signal is sent through the channel interface 58 to the processor 64, where it is used as feedback in control the setting of the micro-actuator driver 18. The micro-actuator driver sends a lateral control signal bundle 82 to each micro-actuator assembly. A separate lateral control signal bundle may control each micro-actuator assembly.

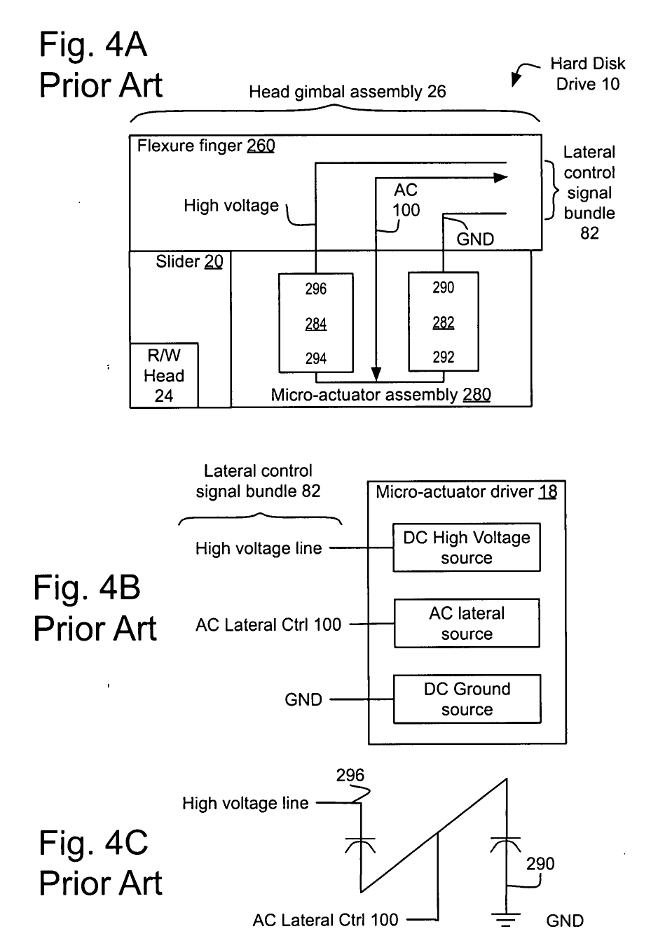

Embodiments of the hard disk drive 10 include embodiments of the head gimbal assembly 26 providing a different lateral control signal bundle 82 from the prior art. A flexure finger 260 typically provides the lateral control signal bundle. In both FIGS. 4A (prior art) and 5A, the micro-actuator assembly 280 includes two piezoelectric devices 282 and 284, each having two terminals used to stimulate laterally positioning of the read-write head 24 of the slider 20 over the rotating disk surface 6. The first piezoelectric device 282 includes a first terminal 290 and a second terminal 292. The second piezoelectric device 284 includes a third terminal 294 and a fourth terminal 296. In both Figures, the micro-actuator assembly 280 couples the second terminal 292 to the third terminal 294.

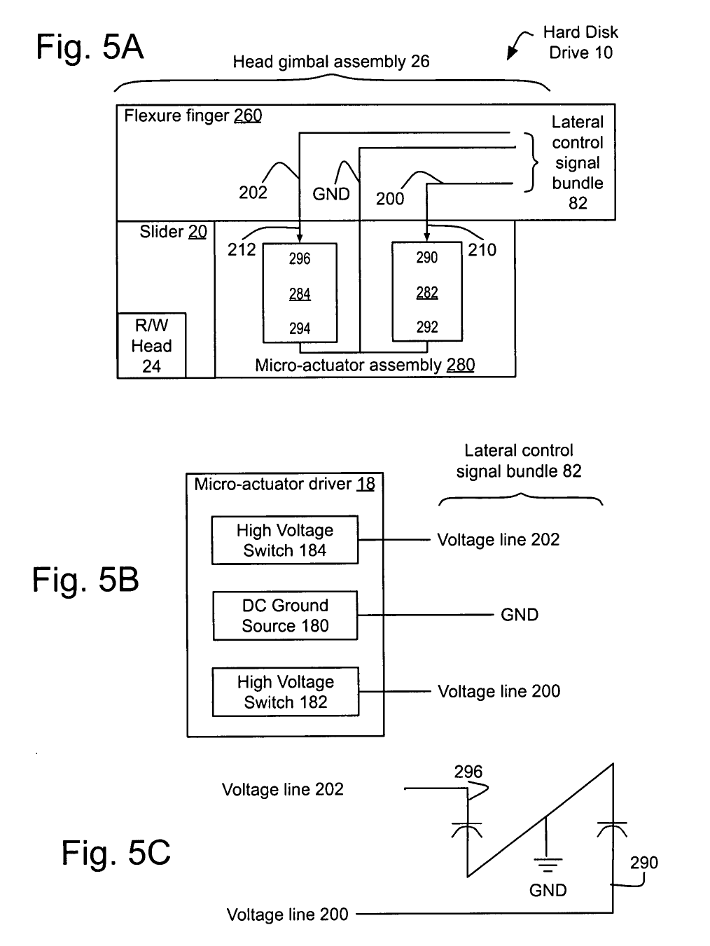

However, the circuitry for driving the piezoelectric devices and the method of operation are quite different from the prior art as will now be explained with reference to FIGS. 5A-C.

The embodiments shown constitute a significant improvement over the prior art designs discussed previously. In these embodiments the micro-actuator driver provides the voltage stimulus to just one of the piezoelectric device terminals. By only dissipating power when one of the piezoelectric devices is needed, power is conserved, and the degradation of the piezoelectric devices over time may be reduced.

FIG. 5A shows an example embodiment of the head gimbal assembly 26, where the lateral control signal bundle 82 including a first voltage control line 200 electrically couples to the first terminal 290, a ground line electrical couples to the second terminal 292 and the third terminal 294, and a second voltage control line 202 electrically couples to the fourth terminal 296. Whereas in the prior art example found in FIG. 4A, the alternating current control line 100 is provided to the electrical coupling between the second terminal 292 and the third terminal 294.

FIG. 5B shows a simplified schematic of an embodiment of the micro-actuator driver 18 used in conjunction with the head gimbal assembly of FIG. 5A. The micro-actuator driver includes a first high voltage switch 182 driving the first voltage line 200, a direct current ground source 180 electrically coupled to the ground line, and a second high voltage switch 184 driving the second voltage line 202. Whereas in the prior art micro-actuator driver shown in FIG. 4B, in place of the direct current ground source 180, there is an alternating current lateral control signal source driving the alternating current lateral control line 100.

In certain embodiments, the micro-actuator driver 18 may provide a first voltage to the first voltage line 200, and may also provide a second voltage to the second voltage line 202. These lines operate to provide the first voltage to the first terminal 290 of the first piezoelectric device 282 and to provide the second voltage to the fourth terminal 296 of the second piezoelectric device 284, both in a micro-actuator assembly 280. The micro-actuator drive may preferably provide only one of these voltages at a time. The first voltage and/or the second voltage may be less than or equal to thirty volts. The first and second voltages may further be less than or equal to twenty volts. The first and second voltages may further be less than or equal to ten volts. The first voltage may or may not be equal to the second voltage.

FIG. 5C shows a simplified circuit schematic of the micro-actuator driver 18 of FIG. 5B driving the lateral control signal bundle 82 of the embodiment of the head gimbal assembly 26 of FIG. 5A. The first voltage line 200 stimulates the first terminal 290 while the second terminal 292 is held to ground to stimulate the first piezoelectric device 282. The second voltage line 202 stimulates the fourth terminal while the third terminal is held to ground to stimulate the second piezoelectric device 284. Whereas in the equivalent prior art circuit shown in FIG. 4C, power is always dissipated, between the direct current high voltage source and the alternating current lateral source and/or between the alternating current lateral source and the direct current ground source.

FIG. 5C further provides an understanding of the method of operating the micro-actuator assembly 280 in the head gimbal assembly 26 and its hard disk drive 10. Altering the lateral position of the read-write head 24 over the rotating disk surface 6 involves stimulating just one piezoelectric device at a time. By stimulating each of the piezoelectric devices independently and only when they are needed, very little, if any, power is wasted during active use of the piezoelectric devices. When neither piezoelectric device is needed, neither the first voltage line 200 nor the second voltage line 202 need be stimulated, again minimizing the dissipated power. This method may further minimize degradation of the piezoelectric devices over time by minimizing their stimulation.

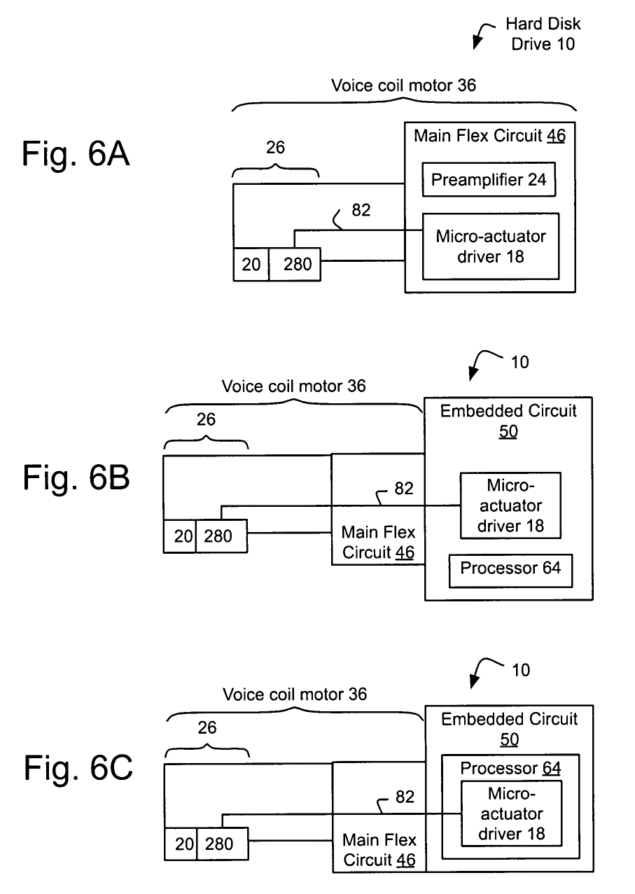

FIG. 6A to 6C show three additional embodiments of the hard disk drive 10 using the head gimbal assembly of FIG. 5A and the micro-actuator driver 18 of FIG. 5B. As already discussed in relation to FIG. 3, the first embodiment of the hard disk drive includes an embodiment of the voice coil motor 36 where the micro-actuator driver 18 is included in the preamplifier 24 in the main flex circuit 46.

FIG. 6A shows a second embodiment of the hard disk drive including an embodiment of the voice coil motor 36 where the micro-actuator driver 18 is separate from the preamplifier 24 in the main flex circuit 46.

FIG. 6B shows a third embodiment of the hard disk drive 10, where the micro-actuator driver 18 is included in the embedded circuit 50, and preferably driven by the processor 64.

FIG. 6C shows a fourth embodiment of the hard disk drive 10, where the micro-actuator driver 18 is included in the processor 64 within the embedded circuit 50.

The preceding embodiments provide examples of the invention and are not meant to constrain the scope of the following claims.

What is claimed is:

1. A hard disk drive, comprising:
a disk base;
a spindle motor mounted on said disk base and configured to rotate said at least one disk to create a rotating disk surface;
a voice coil motor mounted to said disk base to pivot through an actuator pivot at least one actuator arm coupled to at least one head gimbal assembly including a micro-actuator assembly to position a slider over a track on said rotating disk surface, said micro-actuator assembly including a first piezoelectric device and a second piezoelectric device, both mechanically coupled to said slider;
wherein said first piezoelectric device includes a first terminal electrically coupled to a first voltage line and a second terminal electrically coupled to a ground line; and
wherein said second piezoelectric device includes a third terminal electrically coupled to said ground line and a fourth terminal electrically coupled to a second voltage line.

2. The hard drive of claim 1, wherein said head gimbal assembly further comprises a flexure finger providing said first voltage line to said first terminal, said second voltage line to said fourth terminal, and a ground line to said second terminal and to said third terminal.

3. The disk drive of claim 1, wherein a first voltage applied to said first voltage line stimulates only said first piezoelectric device to alter a lateral position of said slider over said rotating disk surface; and wherein a second voltage applied to said second voltage line stimulates only said second piezoelectric device to alter said lateral position of said slider over said rotating disk surface.

4. The hard disk drive of claim 3, wherein said first voltage and said second voltage are less than or equal to 30 volts.

5. The hard disk drive of claim 1, further comprising a micro-actuator driver configured to drive said first voltage line and said second voltage line and further being electrically coupled to said ground line.

6. A head stack assembly comprising at least one head gimbal assembly including a micro-actuator assembly, said micro-actuator assembly including a first piezoelectric device and a second piezoelectric device, both mechanically coupled to a slider;
said first piezoelectric device including a first terminal electrically coupled to a first voltage line and a second terminal electrically coupled to a ground line; and
said second piezoelectric device including a third terminal electrically coupled to said ground line and a fourth terminal electrically coupled to a voltage line.

7. The head stack assembly of claim 6, further comprising a flexure finger providing said first voltage line to said first terminal, said second voltage line to said fourth terminal, and a ground line to said second terminal and third terminal.

8. The head stack assembly of claim 6, wherein a first voltage applied to said first voltage line stimulates only said first piezoelectric device to alter a lateral position of said slider over said rotating disk surface; and wherein a second voltage applied to said second voltage line stimulates only said second piezoelectric device to alter said lateral position of said slider over said rotating disk surface.

9. The head stack assembly of claim 8, wherein said first voltage and said second voltage are less than or equal to 30 volts.

10. The head stack assembly of claim 6, further comprising a micro-actuator driver configured to drive said first voltage line and said second voltage line and further being electrically coupled to said ground line.

11. A head gimbal assembly comprising a micro-actuator assembly including a first piezoelectric device including a first terminal electrically coupled to a first voltage line and a second terminal electrically coupled to a ground line, and a second piezoelectric device including a third terminal electrically coupled to a ground line and a fourth terminal electrically coupled to a second voltage line.

12. The head gimbal assembly of claim 11, wherein a first voltage applied to said first voltage line stimulates only said first piezoelectric device to alter a lateral position of said slider over said rotating disk surface; and wherein a second voltage applied to said second voltage line stimulates only said second piezoelectric device to alter said lateral position of said slider over said rotating disk surface.

13. The head gimbal assembly of claim 11, wherein said first voltage and said second voltage are less than or equal to 30 volts.

14. A method of operating a micro-actuator assembly for positioning a slider over a disk comprising the steps of:
applying a first voltage to a first terminal of a first piezoelectric device having a second terminal electrically coupled to a ground line, to stimulate only said first piezoelectric device to alter a lateral position of a slider over a rotating disk surface; and
applying a second voltage to a fourth terminal of a second piezoelectric device having a third terminal electrically coupled to said ground line, to stimulate only said second piezoelectric device to alter said lateral position of said slider over said rotating disk surface.

15. The method of claim 14, wherein the micro-actuator assembly is mechanically coupled to a head gimbal assembly coupled to a flexure finger providing said first voltage to a first voltage line electrically coupled to said first terminal of said first piezoelectric device, and providing said second voltage to said second voltage line electrically coupled to said fourth terminal of said second piezoelectric device and including at least one ground line.

16. The method of claim 15 further comprising the step of operating a micro-actuator driver to drive said first voltage line and to drive said second voltage line and to further electrically couple to said ground line.

17. The method of claim 14, wherein said first voltage and said second voltage are less than or equal to 30 volts.
